(19) United States
(12) Patent Application Publication
(10) Pub. No.: US 2025/0264167 A1
(43) Pub. Date: Aug. 21, 2025

(54) BENDING RESTRICTOR ASSEMBLY

(71) Applicant: WLH Management and Consulting, Inc., Dallas, TX (US)

(72) Inventors: Tor PERSSON, Houston, TX (US); William HIGGINS, Dallas, TX (US)

(21) Appl. No.: 19/058,343

(22) Filed: Feb. 20, 2025

Related U.S. Application Data
(60) Provisional application No. 63/555,662, filed on Feb. 20, 2024.

(51) Int. Cl. F16L 1/12; F16L 1/20

(52) U.S. Cl. CPC F16L 1/123; F16L 1/20

(57) ABSTRACT

A bending restrictor assembly for permanently bending and restraining ovality of the subsea pipeline has a pipeline section, a first overlying pipe section affixed to the pipeline section, a second overlying pipe section affixed to the pipeline section in spaced relation for the first overlying pipe section, and a plurality of annular members overlying the pipe section and positioned between the first and second overlying pipe sections. The plurality of annular members are translatable along the pipeline section as the pipeline section is bent so as to allow the pipeline section to bend beyond an elastic limit of the pipeline section so as to achieve a permanent bend of the pipeline section.

### CROSS-REFERENCE TO RELATED APPLICATIONS

The present application claims priority to U.S. Patent Application Ser. No. 63/555,662, filed on Feb. 20, 2024.

### FIELD OF THE INVENTION

The present invention relates to apparatus for controlling the bending of a pipeline. In particular, the present invention is a bending restrictor assembly that serves to limit the bending of a pipeline. Additionally, the present invention relates to bending restrictor assemblies that are used to produce control bending of the pipeline beyond elastic limits. The present invention also relates to bending restrictor assemblies which limit the amount of bending that can occur in the pipeline during the installation of the pipeline onto the seafloor.

### BACKGROUND OF THE INVENTION

Subsea pipelines are typically assembled one segment at a time aboard a pipeline installation vessel. As each segment is added, the vessel moves forward and the pipeline follows a descending path to the sea floor. The suspended pipe span between the vessel stern and the sea floor is typically supported partly by a ramp attached to the vessel with axial tension is applied to the pipe which maintains the pipeline bending within elastic boundaries until reaching on the seabed.

The steel pipelines that are laid on the bottom of the sea cannot be pre-formed or pre-adapted to the contour of the sea floor. This is because of the above-identified installation procedure.

There may be tolerated a certain degree of unevenness over which the pipeline is capable of spanning or bending, provided that the specific load does not produce excessively high stresses in the pipeline steel or cause vortex-induced vibrations. If stresses exceed allowable limits, the pipeline could be deformed permanently, either by buckling or cold bending, or both to an unacceptable configuration. Should cold bending occur through yielding of the steel in the pipeline, it could propagate uncontrollably. Requirements set by classification societies for construction and operation of offshore pipelines permit a certain degree of cold bending beyond elastic limits provided that it takes place under controlled conditions. Parameters for such controlled conditions entail that a pipeline may be cold bent to a minimum radius less than what is allowed for uncontrolled bending.

Pipelines that are laid on an uneven sea floor are subjected to free spanning because of the rigidity of the pipeline. Specifications used for submarine pipeline installation permits plastic deformation as long as positive measures are taken to ensure that excessive bending is prevented. By allowing plastic deformation, it is possible to reduce to a considerable degree the occurrence of free spanning Bending beyond elastic limits may be achieved by overloading the pipeline by applying external loads.

Submarine pipelines having a diameter of more than twelve inches usually require a weight coating to achieve negative buoyancy. This is necessary if the pipeline is to be submerged and also maintain a stable state with respect to the sea current. Plastic deformation of a pipeline having a weight coating of concrete will cause the concrete to crack and break loose.

Pipelines are often deployed at significant depths within the subsea environment. As such, these pipelines are subjected to an high amount of hydrostatic pressure. This hydrostatic pressure will tend to deform the pipeline causing collapse. This is particularly the case when attempts are made to bend the pipeline at the subsea location. Ultimately, because of the hydrostatic pressures and the forces of bending, the subsea pipeline will start to ovalize. This is a significant problem since the ovalization of the pipeline can prevent the desired flow of fluids through the pipeline and can prevent apparatus, such as cleaning pigs, from moving freely through the interior of the pipeline. In certain circumstances, the hydrostatic pressure, coupled with the bending of the pipeline, can actually cause a collapse of the pipeline.

The hydrostatic pressures and the ovalization problems could be limited to a certain degree in the subsea pipeline by making the area of the bent section of pipeline of a larger wall thickness. However, such a larger wall thickness would tend to prevent or hamper proper bending of this pipeline section and cause efforts to bend the pipeline in a desired direction to become much more difficult. As such, a need has developed so as to form a bendable pipeline section in which the pipeline section can be bent beyond its elastic limit so as to achieve a permanent bend while, at the same time, enhancing the resistance to ovalization and, resisting the hydrostatic pressure, and limiting the amount of the ovalization.

Referring to FIGS. 1-5, there is shown a prior art bending restrictor assembly in accordance with the teachings of U.S. Pat. No. 8,562,255 to the present inventor and incorporated by reference herein. In general, the bending restrictor assembly of U.S. Pat. No. 8,562,255 is illustrated for the purpose of showing the function of the bending restrictor assembly. It is understood that the present invention provides a different structure which achieves different advantages, but fundamentally, the function and relation between the collar elements and the pipeline section will be of a similar nature. As such, FIGS. 1-5 are instructive as to the overall operation of the present invention and in particular, showing how the bending restrictor assembly of the present invention is suitable for restricting pipeline section movement in both compression and extension.

Referring to FIG. 1, there is shown the bending restrictor assembly 10 in accordance with the teachings of the prior art. As can be seen, the bending restrictor assembly 10 is applied to a pipeline section 12. The pipeline section 12 has a length dimension and an outer diameter. The bending restrictor 10 includes as collar 14 that is affixed to the outer diameter of the pipeline section 12. In particular, collar 14 is illustrated as affixed to a widened thickness portion 16 of the pipeline section adjacent one end of the pipeline section 12. The inclusion of the length of the pipeline section 12 determined by the installation placement of the collar 14 at the widened thickness portion 16 of the pipeline section 12 assures that bending occurs in the area where the wall thickness of the pipeline section is minimal, generally in the central area 18.

As can be seen in FIG. 1, there is plurality of outer collars 20 that are arranged around the outer diameter of the pipeline section 12 and are positioned in generally spaced longitudinal relationship to each other. Each of the collars 20 will extend entirely around a diameter of the pipeline section 12. The first outer collar 22 is illustrated as extending over the outer diameter of the collar 14. A plurality of inner collars 24 are arranged so as to extend between the respective plurality of outer collars 20. The plurality of inner collars 24 are arranged in spaced longitudinal relationship to each other. Each of the plurality of inner collars 24 will have an inner diameter greater than the outer diameter of the pipeline section 12. Each of the inner collars 24 has an outer diameter that generally corresponds to the inner diameter of the outer collars 20. As such, the arrangement of outer collars 20 and inner collars 24 can be slidably linked together so as to fix the bending limits of the pipeline section 12.

An outer collar 26 is located at the end of the bending restrictor assembly 10. Another collar 28 is slidably received within the interior of the outer collar 26. The collar 28 also extends over a widened thickness 30 of the pipeline section 12. Collars 14 and 28 are utilized so as to restrict the bending from affecting the structurally strong connector areas located at the opposite ends of the pipeline section 12. As such, the bending restrictor assembly 10 assures the integrity of the pipeline section upon which it is placed.

FIG. 2 shows a circumferential segment of the bending restrictor assembly 10 of the prior art. As can be seen, the collar 14 is affixed to the pipeline section 12. A pair of slots 32 and 34 are provided on the collar 14 so as to facilitate the ability to weld the collar 14 to the pipeline section 12. The first outer collar 22 is illustrated as extending over the outer diameter of the collar 14. The first outer collar 22 is illustrated as having a pair of keyways 36 and 38 formed through the wall thereof. A pin 40 will extend into the keyway 36. Another pin 42 will extend into the keyway 38. The diameter of the pins 40 and 42, along with the length of the keyways 36 and 38, are components which determine the limit of bend of the pipeline section 12. Another collar 28 is formed at the opposite end of the bending restrictor assembly 10. As can be seen in FIG. 2, each of the keyways has a length greater than the diameter of each of the respective pins.

The first outer collar 22 also includes a hole 44 formed through the wall thereof. A pin 46 is threadedly affixed within the hole 44. Another hole 48 is also formed through the wall of the first outer collar 22. A pin 50 is threadedly received by the hole 48. Pins 46 and 48 will extend radially inwardly of the outer collar 22 so as to be received by keyways 52 and 54 (illustrated in broken line fashion) on the inner collar 24.

In FIG. 2, it can be seen that the inner collar 24 extends through the space between one end of the first outer collar 22 and the second collar 56. Second outer collar 56 has a configuration similar to that of the first outer collar 22. The second outer collar 56 includes suitable keyways and holes so as to facilitate the connection with the inner collar 24. It should be noted that, within the concept of the present invention, all of the pins could be placed into the outer collar so as to extend into keyways in the collars and the inner collars. This facilitates the ability to assemble the bending restrictor assembly.

FIG. 2 shows a limited arrangement of the outer collars 20 and the inner collars 24. Ultimately, the collar 28 is illustrated as extending over the pipeline section 12 at the end of the arrangement of outer collars 20. The collar 28 will include keyway 60 which serves to receive pins 62 affixed within the holes of the second outer collar 56.

FIG. 3 illustrates the arrangement of the outer collars and inner collars at the point of installation upon the pipeline section 12. In FIG. 3, it can be seen that the collar 14 is welded to the outer diameter of the pipeline section 12. The collar 14 includes a hole 64 formed at a location away from the welded connection. The hole 64 is suitably threaded so as to receive a pin 66 therein. Pin 66 has a portion extending into the keyway 68 of the outer collar 70. Because of the use of the keyway 68, the outer collar 64 will be in slidable relationship with the collar 14. The pin 66 serves to limit the amount of sliding motion that can occur.

The outer collar 70 has a threaded hole 72 that receives a pin 74 therein. Pin 74 will extend downwardly so as to be received within a keyway 76 associated with an inner collar 78. The arrangement of holes and keyways facilitates the ability to install the bending restrictor assembly 10 of the present invention. In other words, it is only necessary to align the respective keyways with the respective holes. The pins can then be inserted through the keyway so as to threadedly engage the hole or threadedly inserted into the threaded hole so as to ultimately have a portion extending into the keyway. Other techniques, such as welding or pressing can also be used so as to cause the pins to be fixed within their respective holes.

In FIG. 3, there is a second outer collar 80 also having a keyway 82 and a hole 84 formed therein. The inner collar 78 includes a hole 86 that serves to receive pin 88 therein. Similarly, a second inner collar 90 (or collar) will have a keyway 92 formed therein. Pin 94 is threadedly affixed within hole 84 so as to extend into the keyway 92.

In FIG. 3, since each of the respective pins 66, 74, 88 and 94 reside centrally of the keyways, the pipeline section 12 is in a straight configuration. The spacing of the keyways and holes, along with the spacing of the inner and outer collars, assures that the bending radius of the pipeline section 12 is properly controlled.

FIG. 4 shows the bending restrictor assembly 10 as used in extension. In FIG. 4, the pin 66 has moved so as to abut a side of the keyway 68. The edge 81 of the collar 14 is spaced from the edge 83 of the inner collar 78. Also, the pin 74 abuts a wall of the keyway 76. The edge 85 of the outer collar 70 is spaced further from the edge 87 of the second outer collar 80. Similarly, the pin 68 abuts an end of the keyway 82. Additionally, and furthermore, the pin 94 is moved so as to abut an end of the keyway 92 of the inner collar 90.

FIG. 5 shows the bending restrictor assembly 10 in compression. In this arrangement, the pin 66 abuts another side of the keyway 68. Pin 74 abuts another end of the keyway 76. Pin 88 abuts another end of the keyway 82. Pin 94 will also abut another end of the keyway 92. So as to further restrict bending movement in compression, the end edges 81 and 83 of the collar 14 and the inner collar 78 abut one another. Similarly, the end edges 85 and 87 of the outer collars will abut each other.

In the past, various patents and publications have issued relating to the controlling of the bending of a pipeline. For example, U.S. Pat. No. 5,192,166, issued to the present inventor, describes a method for controlled bending of a pipeline during the laying thereof in the sea. This method utilizes bend controlling/stopping means which are mounted on the pipeline and interact with the pipeline. To achieve cold bending under controlled conditions, the pipeline is weight-loaded internally at the selected bending zone. The weight-loading may be achieved by means of a flexible string of weight elements and/or by introducing into the pipe a suitable heavy, readily flowable weight mass, for example, drilling fluid or water.

U.S. Pat. No. 5,403,121, issued on Apr. 4, 1995 to Lanan, describes a method for accommodating thermal expansion of a buried subsea pipeline. This method includes the steps of providing a pipeline which bends in alternating essentially opposed directions. The angles of the bends and the distance between the bends are sufficiently small so that the pipeline is not plastically deformed when resting on the seabed. The number and angles of the bends are sufficiently large to prevent upheaval buckling. The bend angles and distance between the bends is small enough that the pipeline can be passed through a tensioning machine and ramp of a pipeline-laying vessel. The pipeline can then be installed on the sea floor.

U.S. Pat. No. 1,677,077, issued on Jul. 10, 1928 to D. D. Fortune, describes a hose protector in which a flexible sheath is connected to a collar. The sheath comprises a plurality of sections pivotally connected together. Each section is formed of a plurality of rings. Straps connect the rings together. An end of each strap projects beyond a ring and is pivotally connected to a ring of an adjacent section. The collars form a plurality of section pivotally connected together. This method is applicable for preventing kinking of a flexible hose and not exceeding allowable plastic deformation values.

U.S. Patent Publication No. 2010/0329792, published on Dec. 30, 2010 to the present inventor, describes a controlled bending of a pipeline by an external force. A bending collar assembly is attached to a selected bending zone of the pipeline so as to limit the control bending of the pipeline to a predetermined resulting bending configuration. External force is then applied on the bending collar assembly so as to bend the pipeline to the resulting bending configuration in cooperation with the bending collar assembly and the sea floor. The external force can be exerted from one or more weights placed on top of the bending collar assembly.

U.S. Pat. No. 8,562,255, issued Oct. 22, 2013 to the present inventor, describes a bending restrictor assembly for use with a pipeline section. The bending restrictor assembly has a sleeve affixed to the pipeline section, an outer collar slidably positioned relative to an over the sleeve, and it inner collar slidably positioned relative to an interior of the outer collar. The inner collar is in spaced longitudinal relation to an end of the sleeve. The inner and outer collars are slidable relative to a bending of the pipeline section. A series of holes and keyways are formed in the inner and outer collars. Pins are inserted into corresponding holes and keyways so as to correspond to a limit of the bending radius of the pipeline section.

U.S. Pat. No. 9,822,918, issued on Nov. 21, 2017 to the present inventor, describes a bending restrictor assembly that has a pipeline section, a first pipe section affixed to the pipeline section overlying the outer diameter of the pipeline section, a second pipe section affixed to the pipeline section in spaced relation to the first pipe section and overlying the outer diameter of the pipe section, a first collar element having at least a portion positioned between the first and second pipe sections in which the portion overlies the outer diameter of the pipeline section, a second collar element having at least a portion positioned between the first and second pipe sections which the portion overlies the outer diameter of the pipeline section, and at least one stop member cooperative with the first and second collar elements so as to limit the relative movement of the first and second collar elements so as to limit the bending of the pipeline section.

U.S. Pat. No. 9,982,800, issued on May 29, 2018 to the present inventor, teaches a bending restrictor assembly that is a pipeline section, a first overlying pipe section having a wall overlying a portion of the pipeline section at one end thereof, a second overlying pipe section having a wall overlying another portion of the pipeline section and an opposite end thereof, and a plurality of cylindrical members overlying the pipe section between the first and second overlying pipe sections. The first and second overlying pipe sections extend outwardly beyond the respective ends of the pipeline section. The bending restrictor assembly achieves a permanent bend and restricts ovality of a subsea pipe.

It is an object of the present invention to provide a bending restrictor assembly that allows cold bending of the pipeline to be achieved at the seabed during pipeline installation operations.

It is another object the present invention to provide a bending restrictor assembly which allows for the pipeline to bend beyond the elastic limit of the pipeline.

It is another object the present invention to provide a bending restrictor assembly that effectively limits the amount of the bend of the pipeline.

It is another object of the present invention to provide a bending restrictor assembly that avoids the ovalization in the area of the bend.

It is another object of the present invention to provide a bending restrictor assembly that resists the effect from hydrostatic pressures.

It is another object the present invention to provide a bending restrictor assembly that enhances the strength of the pipeline section at the ends of the bent pipeline section.

It is another object of the present invention to provide a bending restrictor assembly that avoids the collapse of the pipeline.

It is another object of the present invention provide a bending restrictor assembly which allows a pipe with a greater wall thickness to be joined to the bent pipeline section.

It is still another object of the present invention to provide a bending restrictor assembly that achieves a predetermined bend radius.

It is another object of the present invention to provide a bending restrictor assembly that can reduce the pipeline length and reduce costs.

It is an object of the present invention to provide a bending restrictor assembly that allows cold bending to be achieved at the seabed during pipeline installation operations.

It is another object the present invention to provide a bending restrictor assembly which allows for a pipeline to bend within predetermined limits.

It is another object of the present invention to provide a bending restrictor assembly which, when applied, can alleviate seabed preparation and post-installation corrections.

It is another object of the present invention to provide a bending restrictor assembly which can be installed on the pipeline section before being added to the pipeline as part of a final installation.

It is another object of the present invention to provide a bending restrictor assembly which can result in significant cost savings.

It is still further object of the present invention to provide a bending restrictor assembly which provides for the easy installation of smooth transition areas between the pipeline and the bending restrictor assembly.

It is still another object of the present invention provide a bending restrictor assembly which enhances the strength of the pipeline in the area of the transition between the pipeline of the bending restrictor assembly.

These and other objects and advantages of the present invention will become apparent from a reading of the attached specification and appended claims.

### SUMMARY OF THE INVENTION

The present invention is a bending restrictor assembly for permanently bending and restraining ovality of a subsea pipe. This bending restrictor assembly includes a pipeline section having an outer diameter, a first end and a second end. A first overlying pipe section has a wall overlying a portion of the pipeline section at the first end thereof. The first overlying pipe section has an outer diameter greater than an outer diameter of the pipeline section. A second overlying pipe section has a wall overlying another portion of the pipeline section at the second end thereof. The second overlying pipe section has an outer diameter greater than the outer diameter of the pipeline section. A plurality of annular members overlie the pipeline section between the first and second overlying pipe sections. The plurality of annular members are translatable along the pipeline section as the pipeline section is bent so as to allow the pipeline section to bend beyond an elastic limit of the pipeline section so as to achieve a permanent bend of the pipeline section and to restrain ovality.

A first overlying pipe section has at least one flange extending radially outwardly thereof. One of the plurality of annular members has a surface bearing against this flange. In particular, the first overlying pipe section has a pair of flanges extending circumferentially therearound longitudinally spaced relation to each other. The surface of one of the plurality of annular members is received between the pair of flanges. This annular member has an inwardly extending portion formed away from the surface received between the pair of flanges and the first overlying pipe section. Another annular member has an outwardly extending flange received by the portion and the surface of the plurality of flanges. This annular member has an inner surface translatable with respect to the outer diameter of the pipeline section. This annular member has a second outwardly extending flange formed in spaced relation to the first outwardly extending flange.

The second overlying pipe section also has at least one flange extending radially outwardly thereof. One of the plurality of annular members has a surface bearing against this flange. In particular, the second overlying pipe section includes a pair of flanges extending circumferentially therearound in longitudinally spaced relation to each other. The surface of the annular member is received between the pair of flanges. The annular member has an inwardly extending portion formed away from the surface received between the pair of flanges and the second overlying pipe section. Another annular member has an outwardly extending flange received by the portion and the surface of the flange. This annular member has an inner surface translatable with respect to the outer diameter of the pipeline section. This annular member has a second outwardly extending flange formed in spaced relationship to the first outwardly extending flange.

Each of the first overlying pipe section and the second overlying pipe section is shrink fit over the pipeline section and secured to the final assembly by welding to the adjoining pipeline section. The plurality of annular members can be shrink-fit onto respective first overlying pipe section and the second overlying pipe section. Each of the plurality of annular members can comprise a first half-cylinder and a second half-cylinder affixed to the first half-cylinder so as to extend entirely around the pipeline section. The first half cylinder can be joined to the second half cylinder by set screws.

The plurality of annular members are in slidable interlocking relation to each other so as to translate relative to a bend of the pipeline section. The plurality of annular members each has an inner diameter slightly spaced from the outer diameter of the pipeline section so as to restrain the ovality of the subsea pipe. The plurality of annular members, in particular, comprises a first plurality of annular members engaged with the first and second overlying pipe sections, a second plurality of annular members having a surface adjacent the outer diameter of the pipeline section, and a third plurality of annular members positioned over and around adjacent pairs of the second plurality of annular members. The first plurality of annular members comprises a collar having three inwardly extending surfaces extending around an inner diameter thereof. The three inwardly extending surfaces are in spaced relation to each other. The second plurality of annular members comprises a collar having a first outwardly extending flange extending therearound and a second outwardly extending flange extending therearound. The first and second outwardly extending flanges are formed between adjacent ends of the collar. The third plurality of annual members includes a collar having a first inwardly extending surface and a second inwardly extending surface in spaced relation around an inner diameter of the collar.

This foregoing Section is intended to describe, with particularity, the preferred embodiments of the present invention. It is understood that modifications to this preferred embodiment can be made within the scope of the present claims. As such, this Section should not to be construed, in any way, as limiting of the broad scope of the present invention. The present invention should only be limited by the following claims and their legal equivalents.

### BRIEF DESCRIPTION OF DRAWINGS

FIG. 1 is a cutaway view of the bending restrictor assembly of the prior art is applied to a pipeline section.

FIG. 2 is a plan, partially-transparent view showing the bending restrictor assembly of the prior art.

FIG. 3 is a part partial cross-sectional view showing the bending restrictor assembly of the prior art is applied to a pipeline section in which the bending restrictor assembly in an originally assembled position.

FIG. 4 is a partial cross-sectional view of the bending restrictor assembly of the prior art as applied to the pipeline section in which the bending restrictor assembly is shown in extension.

FIG. 5 is a partial cross-sectional view of the bending restrictor assembly of the prior art which the bending restrictor assembly is shown in compression.

FIG. 6 is a cross-sectional side view showing the bending restrictor assembly in accordance with the teachings of the present invention.

FIG. 7 is a cross-sectional view showing the pipeline section in which the bending restrictor assembly of the present invention is applied.

FIG. 8 is a cross-sectional view of the first overlying pipe section of the present invention.

FIG. 9 is a cross-sectional view showing one of the first plurality of annular members as used in the bending restrictor assembly of the present invention.

FIG. 10 is a cross-sectional view showing one of the second plurality of annular members as used in the bending restrictor assembly of the present invention.

FIG. 11 is a cross-sectional view showing one of the third plurality of annular members as used in the bending restrictor assembly of the present invention.

FIG. 12 is a cross-sectional view showing an interface between the pipeline section and the first overlying pipe section in which the first overlying pipe section is shrink-fit in which the end sections are closed by welding.

FIG. 13 is a cross-sectional view of the present invention showing the interface between the pipeline section and the first overlying pipe section in which the pipeline is internally welded.

FIG. 14 is a cross-sectional view of the present invention showing the pipeline section and the first overlying pipe section as welded to the pipeline section with gaps between the plurality of annular members prior to installing the third plurality of annular members.

FIG. 15 is a cross-sectional view of the bending restrictor assembly of the present invention in which the pipeline section is connected with an inflatable packer or spring-loaded friction connection to the first overlying pipe section.

FIG. 16 is a cross-sectional view of the annular member showing the annular member as being a pair of half-cylinders.

FIG. 17 is a cross-sectional view of the plurality of annular members in which the plurality of annular members are shrink-fit into position onto the bending restrictor assembly.

FIG. 18 is a partial cross-sectional view of an alternative embodiment of the bending restrictor assembly of the present invention.

FIG. 19 is a detailed partial cross-sectional view of an alternative embodiment of FIG. 18 of the bending restrictor assembly of the present invention.

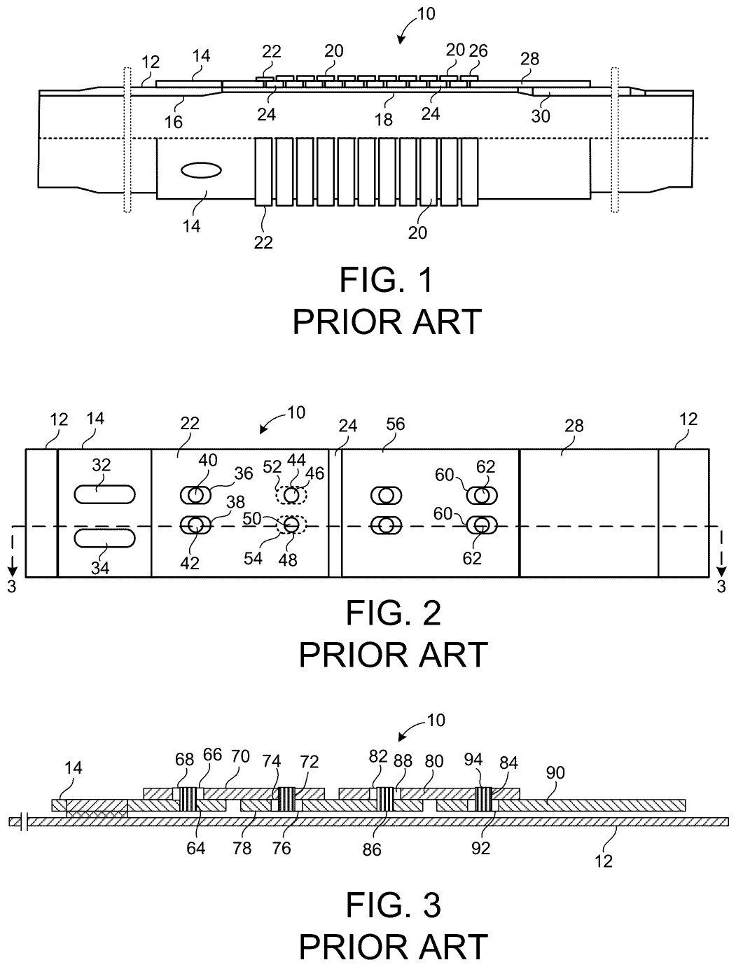

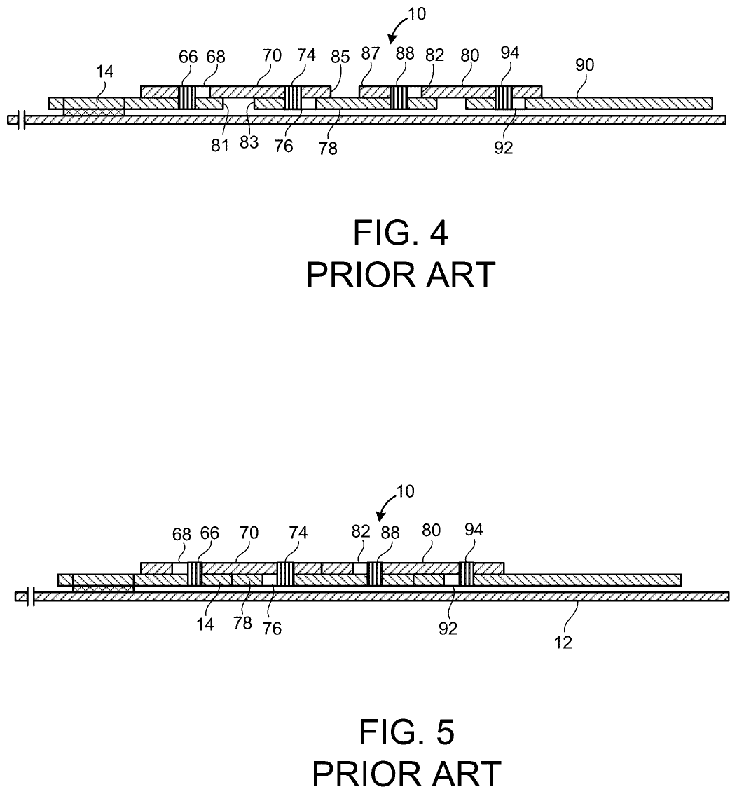

### DETAILED DESCRIPTION OF THE INVENTION

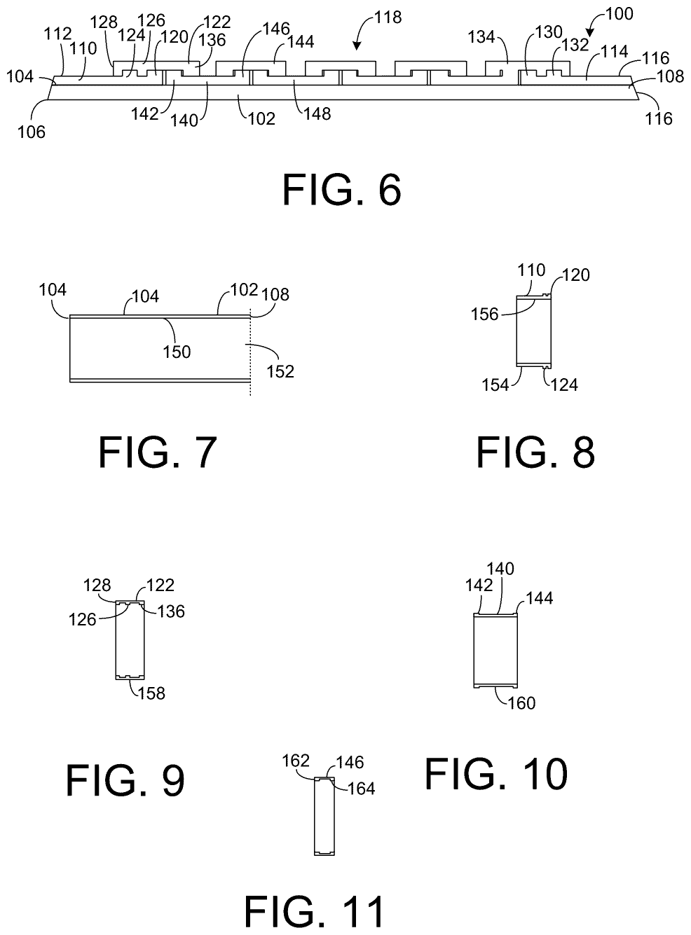

Referring to FIG. 6, there is shown the bending restrictor assembly 100 in accordance with the teachings of the present invention. Bending restrictor assembly 100 is for permanently bending and restraining ovality of a subsea pipe. The bending restrictor assembly 100 includes a pipeline section 102 having an outer diameter 104, a first end 106 and a second end 116. A first overlying pipe section 110 has a wall overlying a portion of the pipeline section 102. The first overlying pipe section 110 is located adjacent to the first end 106 of the pipeline section 102. A second overlying pipe section 114 has a wall overlying a portion of the pipeline section 102 at the second end 116 thereof. The second overlying pipe section 114 has an inner diameter greater than the outer diameter of the pipeline section 102. A plurality of annular members 118 (described in greater detail in association FIG. 7-11) overlie the pipeline section 102 between the first overlying pipe section 110 and the second overlying pipe section 114. The plurality of annular members 118 are translatable along the pipeline section 102 as the pipeline section 102 is bent so as to allow the pipeline section 102 to bend beyond an elastic limit of the pipeline section 102 so as to achieve a permanent bend of the pipeline section 102.

The first overlying pipe section 110 has a first flange 120 extending radially outwardly thereof. An annular member 122 of the plurality of annular members 118 has a surface bearing against this flange 120. The first overlying pipe section 110 also has a second flange 124 extending circumferentially therearound and in spaced relation to the first flange 120. A surface 126 of the first annular member 122 is received between the first flange 120 and the second flange 124. The first annular member 122 has another surface 128 that will bear against the second flange 124 on the side of the second flange 124 opposite the first flange 120. As such, the first annular member 122 is secured to the first overlying pipe section 110. The second overlying pipe section 114 slid over the pipeline section 102 and includes a first flange 130 and a second flange 132 extending outwardly therefrom. First flange 130 and second flange 132 are joined with another annular member 134 of the plurality of annular members 118. This another annular member 130 has a configuration identical to the first annular member 122. As such, the annular member 134 has a surface received between the first flange 130 and the second flange 132 of the second overlying pipe section 114. Another surface of the another annular member 134 will bear against a side of the second flange 132 opposite the first flange 130. Each of the flanges 130 and 132 extend circumferentially around the second overlying pipe section 114 in spaced relation to each other. The first annular member 122 has an another inwardly extending surface 136 extending circumferentially inwardly in spaced relation to the inwardly extending surface 126.

FIG. 6 shows that there is a second annular member 140 that has an pair of outwardly extending flanges 142 and 144. Outwardly extending flange 142 of the second annular member 140 is received between the inwardly extending surface 136 of the first annular member 122 and the first flange 120 of the first overlying pipe section 110. It can be seen that there are spaces between the surfaces of the first annular member 122 so as to allow the second annular member 140 to translate with respect to the first annular member 122 relative to the outer diameter of the pipeline section 102. A third annular member 146 of the plurality of annular members 118 has a pair of inwardly extending surfaces that are received by the second annular member 140 and another second annular member 148. This pattern of annular members repeats for any desired distance along the length of the pipeline section 102 between the first overlying pipe section 110 and the second overlying pipe section 114.

Importantly, in the present invention, the first and second overlying pipe sections 110 and 114 essentially increase the section modulus of the pipeline section 102. As such, the pipeline section 102, which is to be bent, is very strong at the respective ends 104 and 108. Generally, the maximum thickness of the first and second overlying sections 110 and 114 will match the wall thickness of the adjoining pipeline sections 102. The relatively thin wall thickness of the pipeline section 102 between the overlying pipe sections 110 and 114 facilitates the locating of a place for a bend to occur. The annular members 118 effectively enhance the section moduluss of the narrow wall thickness area of the pipeline section 102. This serves to restrict any ovalization of the pipeline section 102 during bending. Furthermore, the annular members 118 serve to resist the hydrostatic pressures that could be exerted on the relatively thin wall pipeline section 102. The arrangement of annular members 118 effectively can set the desired bend of the pipeline section 102 so that the pipeline section 102 exceeds its elastic limit in order to achieve a permanent bend while, at the same time, limiting the amount of the bend. The size, arrangement, number and spacing of the annular members 118 can be predetermined in order to achieve the desired bend.

FIG. 7 shows a cross-sectional view of the pipeline section 102. As can be seen, the pipeline section 102 includes the outer diameter 104 and an inner diameter 150. An interior passageway 152 facilitates the ability of fluids to pass therethrough. Pipeline section 102 has a first end 106 and a second end 108.

FIG. 8 shows a cross-sectional view of the first overlying pipe section 110. The second overlying pipe section 114 will have a similar configuration. The first overlying pipe section 110 is illustrated as having the first flange 120 and the second flange 124 extending circumferentially therearound in spaced relationship to each other. The inner diameter 156 of the first overlying pipe section 110 will generally match the outer diameter 104 of the pipeline section 102.

The first annular member 122 is shown, in particular, in FIG. 9. It can be seen that the first annular member 122 comprises a collar 158 having three inwardly extending surfaces 136, 126 and 128 formed in spaced relation to each other. These inwardly extending surfaces 136, 126 and 128 extend circumferentially around the inner diameter of the first annular member 122.

FIG. 10 illustrates the second annular member 140. Second annular member 140 has a first outwardly extending flange 142 and a second outwardly extending flange 144. Flanges 142 and 144 extend circumferentially around outer diameter 160 of the second annular member 140.

FIG. 11 shows the third annular member 146. Third annular member 146 includes a first inwardly extending surface 162 and a second inwardly extending surface 164. Each of the plurality of annular members 118, including first annular member 122, second annular member 140 and third annular member 146 are engageable with each other so as to be translatable with respect to each other and with respect to the first overlying pipe section 110 and the pipeline section 104.

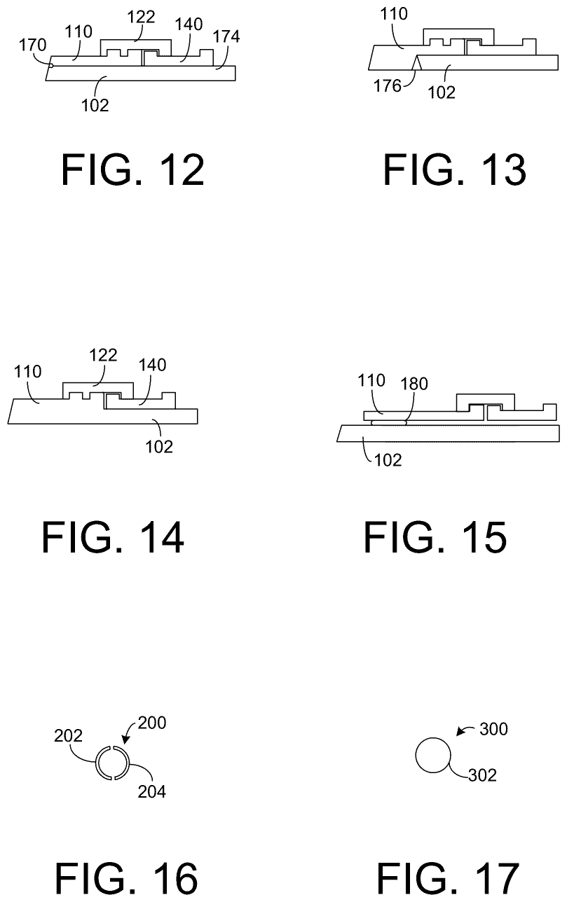

FIG. 12 is a detailed view showing an interface between the pipeline section 102 and the first overlying pipe section 110. In particular, the first overlying pipe section 110 can have an end portion 170 that is welded to the pipeline section 102 so as to fix the first overlying pipe section 110 in position. A similar arrangement can be conducted with respect to the second overlying pipe section 114. The first annular member 122 is shrink-fit into and over the respective outwardly extending flanges of the first overlying pipe section 110 and also shrink-fit over the second annular member 140. As can be seen, there is a small space between an end wall of the first overlying pipe section 110 and an end surface of the second annular member 140. There is a slight space 174 between the inner surface of the second annular member 140 and the outer diameter of the pipeline section 102.

FIG. 13 shows that the first overlying pipe section 110 is affixed to the pipeline section 102 by an internal weld 176.

FIG. 14 illustrates the pipeline section 102 as being affixed to the first overlying pipe section 110. The first overlying pipe section 110 will be welded, in one manner or another, to the pipeline section 102. The first annular member 122 will be secured to the second annular member 140 prior to installing the third annular member 146.

FIG. 15 illustrates that an inflatable packer 180 can be positioned on the outer diameter of the pipeline section 102 so as to fixedly engage with the first overlying pipe section 110. The inflatable packer 118 can be replaced with a spring-loaded friction connector.

FIG. 16 is a cross-sectional view of the annular members as used in the present invention. It can be seen in FIG. 16 that the annular member 200 has a first half cylinder 202 and a second half cylinder 204. Each of these half cylinders can be joined together by set screws so as to encircle the respective component of the bending restrictor assembly 100 of the present invention. As such, the various annular members can be assembled in a quick, easy and efficient manner and in the manner shown in FIG. 6. Suitable lock plates can be included within each of the half cylinders 102 and 104 so that set screws will effectively join the half cylinders 102 and 104 together.

FIG. 17 shows an alternative embodiment of the cross-section of the annular members 300. It can be seen at the annular member 300 is entirely circular in cross-section. As such, the circular portion 302 of the annular member 300 can act as a shrink-fit collar so as to engage with each of the other annular members and with the first and second overlying pipe sections in a manner shown in FIG. 6.

It should be noted that the grooves of the first annular member and the third annular member are designed for horizontal compression and shear where the annular members 118 are formed of high strength forged steel. The compression strength of the pipeline specification determines the height and the shear strength determines the horizontal dimensions of these grooves. The bending capacity is determined by the lengths of the annular members and the gaps between them.

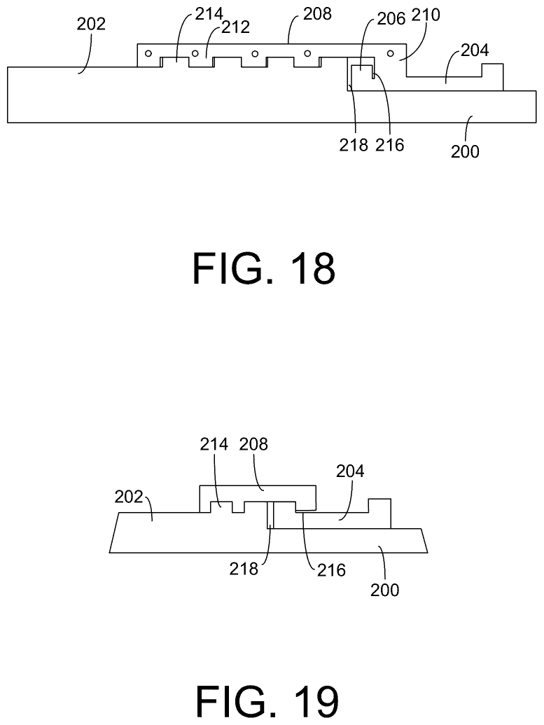

FIG. 18 shows an alternative embodiment of the present invention. Pipeline section 200 has a collar 202 affixed thereto. A collar 204 is positioned over the pipeline section 200. Collar 204 has an end 206 that is received by another collar 208. Section 206 will reside in a space between the end 210 of the collar 208 and a wall of the collar 202 on the pipeline section 200. Collar 208 that are received within corresponding annular members 214 of collar 202. Collar 204 can be secured to the pipeline section 200 by a suitable threaded screw or other type of fastener, such as a shrink-fit connection.

A tension force on the collar 204 will cause the interface 216 to close. A compression force on the collar 204 (by way of a bending of the pipeline section 200) will cause the gap 218 to close.

FIG. 19 shows a further close-up view of the alternative embodiment of FIG. 18. As can be seen, the pipeline section 200 will have a collar 202 affixed thereto. Another collar 208 is engaged with the projections 214 on the collar 202. The collar 204 can be secured to the pipeline section 200 by screws or by other means, such as shrink wrap. Once again, any tension applied to the pipeline section 200 as a result of bending will cause the gap 216 to close. Any compression forces applied to the pipeline section 200 will cause relative movement between the collars 202 and 204 so as to cause the gap 218 to close.

The foregoing disclosure and description of the invention is illustrative and explanatory thereof. Various changes in the details of the illustrated construction can be made is the scope of the present invention without departing from the true spirit of the invention. The present invention should only be limited by the following claims and their legal equivalents.

1. A bending restrictor assembly for permanently bending and restraining ovality of a subsea pipeline, the bending restrictor assembly comprising:
a pipeline section having an outer diameter and a first end and a second end;
a first overlying pipe section having a wall overlying a portion of said pipeline section at the first end thereof, said first overlying pipe section having an inner diameter greater than the outer diameter of said pipeline section;
a second overlying pipe section having a wall overlying another portion of said pipeline section at the second end thereof, said second overlying pipe section having an inner diameter greater then the outer diameter of said pipeline section; and
a plurality of annular members overlying said pipeline section between the first and second overlying pipe sections, said plurality of annular members being translatable along said pipeline section as said pipeline section is bent so as to allow said pipeline section to bend beyond an elastic limit of said pipeline section so as to achieve a permanent bend of said pipeline section.

2. The bending restrictor assembly of claim 1, said first overlying pipe section having at least one flange extending radially outwardly thereof, one of said plurality of annular members having a surface bearing against the at least one flange.

3. The bending restrictor assembly of claim 2, said first overlying pipe section having a pair of flanges extending circumferentially therearound in a longitudinally spaced relationship to each other, the surface of the one of said plurality of annular members being received between the pair of flanges.

4. The bending restrictor assembly of claim 3, the one of said plurality of annular members having an inwardly extending portion formed away from the surface received between the plurality of flanges of said first overlying pipe section.

5. The bending restrictor assembly of claim 4, wherein said plurality of annular members further comprises:
another annular member having a first outwardly extending flange received by the portion of the surface of the one of said plurality of flanges, said another annular member having an inner surface translatable with respect to the outer diameter of said pipeline section.

6. The bending restrictor assembly of claim 5, wherein the another annular member has a second outwardly extending flange formed in spaced relation to the first outwardly extending flange.

7. The bending restrictor assembly of claim 1, wherein said second overlying pipe section has at least one flange extending radially outwardly thereof, one of said plurality of annular members having a surface bearing against the at least one flange of said second overlying pipe section.

8. The bending restrictor assembly of claim 7, said second overlying pipe section having a pair of flanges extending circumferentially therearound and in longitudinally spaced relation to each other, the surface of the one of said plurality of annular members being received between the pair of flanges.

9. The bending restrictor assembly of claim 8, the one of said plurality of annular members having an inwardly extending portion formed away from the surface received between the pair of flanges of said second overlying pipe section.

10. The bending restrictor assembly of claim 9, wherein said plurality of annular members further comprises:
another annular member having an outwardly extending flange received by the portion and the surface of the one of said plurality of flanges, said another annular member having an inner surface translatable with respect to the outer diameter of said pipeline section.

11. The bending restrictor assembly of claim 10, wherein the another annular member has a second outwardly extending flange formed in spaced relation to the first outwardly extending flange.

12. The bending restrictor assembly of claim 1, each of said first overlying pipe section and said second overlying pipe section being welded to the outer diameter of said pipeline section.

13. The bending restrictor assembly of claim 1, wherein said plurality of annular members are slid onto respective said first overlying pipe section and said second overlying pipe section.

14. The bending restrictor assembly of claim 1, wherein each of said plurality of annular members comprises:
a first half-cylinder; and
a second half-cylinder affixed to said first half-cylinder so as to extend entirely around said pipeline section.

15. The bending restrictor assembly of claim 14, said first half-cylinder being joined to said second half cylinder by set screws or a shrink fit outer band.

16. The bending restrictor assembly of claim 1, wherein said plurality of annular members are in slidable interlocking relation to each other so as to translate relative to a bend of said pipeline section.

17. The bending restrictor assembly of claim 1, wherein said plurality of annular members each has an inner diameter slightly spaced from the outer diameter of said pipeline section so as to restrain the ovality of the subsea pipe.

18. The bending restrictor assembly of claim 1, wherein said plurality of annular members comprises:
a first plurality of annular members engaged with the first and second overlying pipe section;
a second plurality of annular members having a surface adjacent the outer diameter of said pipeline section; and
a third plurality of annular members positioned over and around adjacent pairs of said second plurality of annular members.

19. The bending restrictor assembly of claim 18, wherein said first plurality of annular members and comprises a collar having three inwardly extending surfaces extending around an inner diameter thereof, the three inwardly extending surfaces being in spaced relation to each other.

20. The bending restrictor assembly of claim 18, wherein said second plurality of annular members comprises a collar having a first outwardly extending flange extending therearound in a second outwardly extending flange extending therearound, the first and second outwardly extending flanges formed adjacent opposite ends of the collar.

21. The bending restrictor assembly of claim 18, wherein said third plurality of annular members comprises a collar having a first inwardly extending surface and a second inwardly extending surface in spaced relation to each other around an inner diameter of said collar.
